(19) United States
(12) Patent Application Publication
(10) Pub. No.: US 2020/0205085 A1
(43) Pub. Date: Jun. 25, 2020

(54) UPLINK TRANSMIT POWER CONTROL

(71) Applicant: CONVIDA WIRELESS, LLC, Wilmington, DE (US)

(72) Inventors: Qing LI, Princeton Junction, NJ (US); Guodong ZHANG, Woodbury, NY (US); Lakshmi R. IYER, King of Prussia, PA (US); Allan Y. TSAI, Boonton, NJ (US); Yifan LI, Conshohocken, PA (US)

(21) Appl. No.: 16/621,043

(22) PCT Filed: Jun. 15, 2018
(86) PCT No.: PCT/US2018/037761

§ 371 Date: Dec. 10, 2019

Related U.S. Application Data
(60) Provisional application No. 62/520,368, filed on Jun. 15, 2017.

(51) Int. Cl. H04W 52/14; H04W 52/24; H04W 16/28; H04W 80/08; H04W 52/32; H04W 52/42

(52) U.S. Cl. CPC H04W 52/146; H04W 52/242; H04W 16/28; H04W 52/42; H04W 80/08; H04W 52/246; H04W 52/325; H04W 52/241

(57) ABSTRACT

Methods and systems for uplink transmit power control are disclosed. In a first aspect, methods and systems are disclosed for beam specific uplink transmit power control. In a second aspect, methods and systems are disclosed for uplink transmit power control for a user equipment at an idle or an inactive state. In a third aspect, methods and systems are disclosed for uplink transmit power control for dynamic blocking. In a fourth aspect, methods and systems are disclosed for uplink transmit power control using mixed numerologies and priorities.

### CROSS-REFERENCE TO RELATED APPLICATION

This application claims the benefit of U.S. Provisional Application No. 62/520,368, filed Jun. 15, 2017, the disclosure of which is hereby incorporated by reference in its entirety.

### BACKGROUND

In LTE, Uplink (UL) Power Control (PC) may be used to limit intracell and intercell interference, reduce user equipment (UE) power consumption, and to improve uplink throughput performance. UL Transmit Power Control (TPC) may be conducted in open loop or closed loop. In open loop, the UL TPC may be based on a Path Loss (PL) estimate in the downlink (DL), which may be obtained based on a Cell Reference Signal (CRS). The Open Loop Power control may be performed using Fractional scaling with Path Loss, (if this feature is enabled). In closed loop, a Power Control command (e.g., absolute or accumulative) from the eNB may increase power or decrease power indicated by a TPC bit in the Downlink Control Information (DCI) from the eNB. Based on the TPC, the UE may either increase or decrease its power as instructed to compensate for the path loss.

In LTE, Power Headroom (PH) is a type of MAC Control Element (CE) that reports the headroom between the current UE transmit power (estimated power) and the nominal power. For LTE Dual Connectivity (DC), UL power headroom management is defined for synchronous and asynchronous operations between a Master Cell Group (MCG) and a Secondary Cell Group (SCG). Two example types of power control modes are defined in 3GPP TS 36.213 Physical layer procedures; (Release 14), V14.1.0.

### SUMMARY

Methods and systems for uplink transmit power control are disclosed. In a first aspect, methods and systems are disclosed for beam specific uplink transmit power control. An example method may comprise dynamically adapting beam pair link adjustments and statically or semi-statically adjusting open loop transmit power control parameters. In a first aspect, methods and systems are disclosed for uplink transmit power control for a user equipment at an idle or an inactive state. An example method may comprise detecting a plurality of beams in a downlink transmission to a user equipment, selecting a given one of the beams based on one or more downlink measurements, calculating the downlink path loss based on the selected beam, estimating an uplink path loss based on the downlink path loss of the selected beam, and determining an initial transmit power level for the user equipment based on the estimated uplink path loss. In a third aspect, methods and systems are disclosed for uplink transmit power control with dynamic blocking. In a fourth aspect, methods and systems are disclosed for uplink transmit power control using mixed numerologies and priorities.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1 shows a flow chart of an example method for determining a beam pair link gain difference Δbpl_ki and Δbpl_kj;

FIG. 2 shows a call flow of an example method for estimating a beam pair link gain difference Δbpl_m for the best beam pair m during Downlink (DL) beam training or pairing;

FIG. 3 shows a call flow of an example method for estimating a beam pair link gain difference Δbpl_n for the best beam pair n during Uplink (UL) beam training or pairing;

FIG. 4 shows a call flow of an example method for determining a Synchronization Signal (SS) burst based path loss measurement;

FIG. 5 shows a call flow of an example method for determining a Physical Downlink Control Channel-Demodulation Reference signal (PDCCH-DMRS) based path loss measurement;

FIG. 6 shows a flow chart of an example method for TPC with dynamic blocking;

FIG. 7 shows a call flow of another example method for TPC with dynamic blocking;

FIG. 8 shows an example of a UE's transmit power allocations between services with different numerologies;

FIG. 9 shows an example of a UE's transmit power allocations with different scheduling;

FIG. 10 shows an example method for the implementation of hybrid power sharing with Mini-TTI; and

FIG. 11 shows a flow chart of an example method for hybrid power sharing with Power Headroom Report.

FIG. 12A shows one embodiment of an example communications system in which the methods and apparatuses described and claimed herein may be embodied;

FIG. 12B shows a block diagram of an example apparatus or device configured for wireless communications in accordance with the embodiments illustrated herein;

FIG. 12C shows a system diagram of an example radio access network (RAN) and core network in accordance with an embodiment;

FIG. 12D shows another system diagram of a RAN and core network according to another embodiment;

FIG. 12E shows another system diagram of a RAN and core network according to another embodiment; and

FIG. 12F shows a block diagram of an exemplary computing system 90 in which one or more apparatuses of the communications networks illustrated in FIGS. 12A, 12C, 12D and 12E may be embodied.

### DETAILED DESCRIPTION OF ILLUSTRATIVE EMBODIMENTS

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), and LTE-Advanced standards. 3GPP has begun working on the standardization of next generation cellular technology, called New Radio (NR), which is also referred to as “5G”. 3GPP NR standards development is expected to include the definition of next generation radio access technology (new RAT), which is expected to include the provision of new flexible radio access below 6 GHz, and the provision of new ultra-mobile broadband radio access above 6 GHz. The flexible radio access is expected to consist of a new, non-backwards compatible radio access in new spectrum below 6 GHz, and it is expected to include different operating modes that can be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 6 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (e.g., broadband access in dense areas, indoor ultra-high broadband access, broadband access in a crowd, 50+ Mbps everywhere, ultra-low cost broadband access, mobile broadband in vehicles), critical communications, massive machine type communications, network operation (e.g., network slicing, routing, migration and interworking, energy savings), and enhanced vehicle-to-everything (eV2X) communications. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, and virtual reality to name a few. All of these use cases and others are contemplated herein.

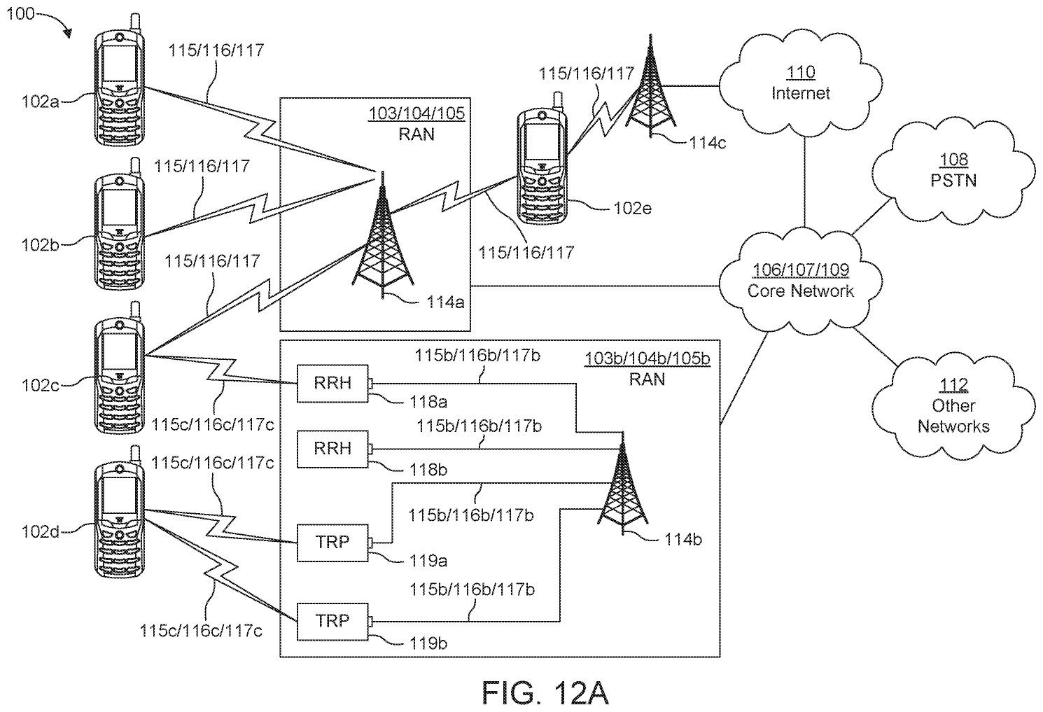

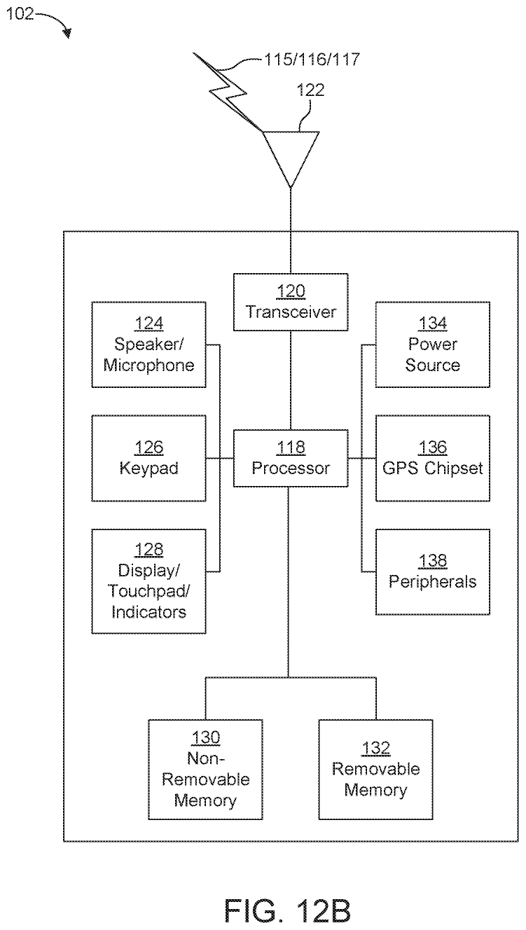

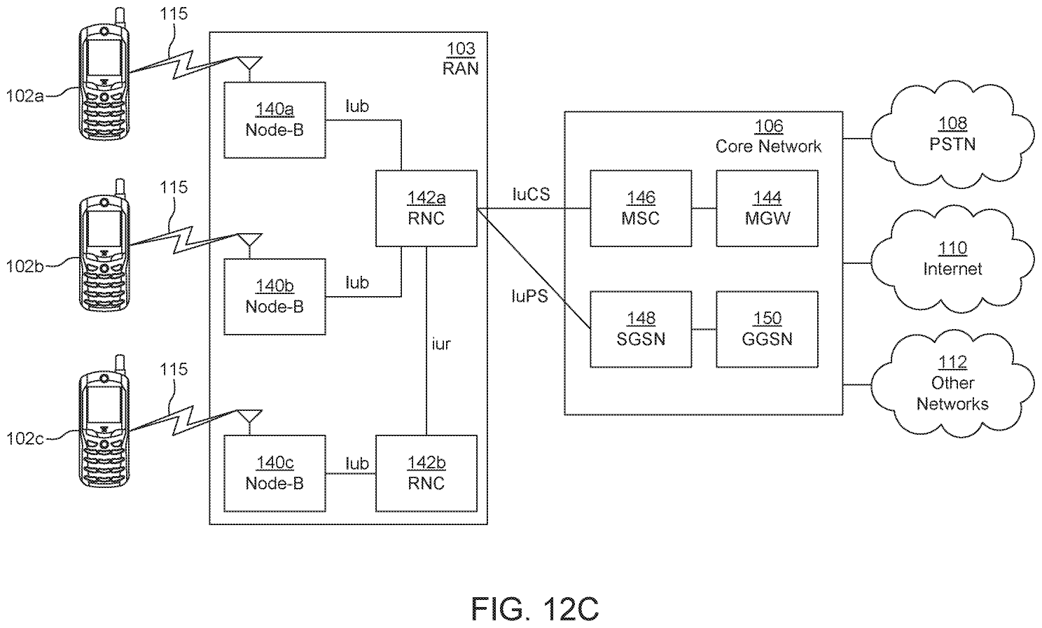

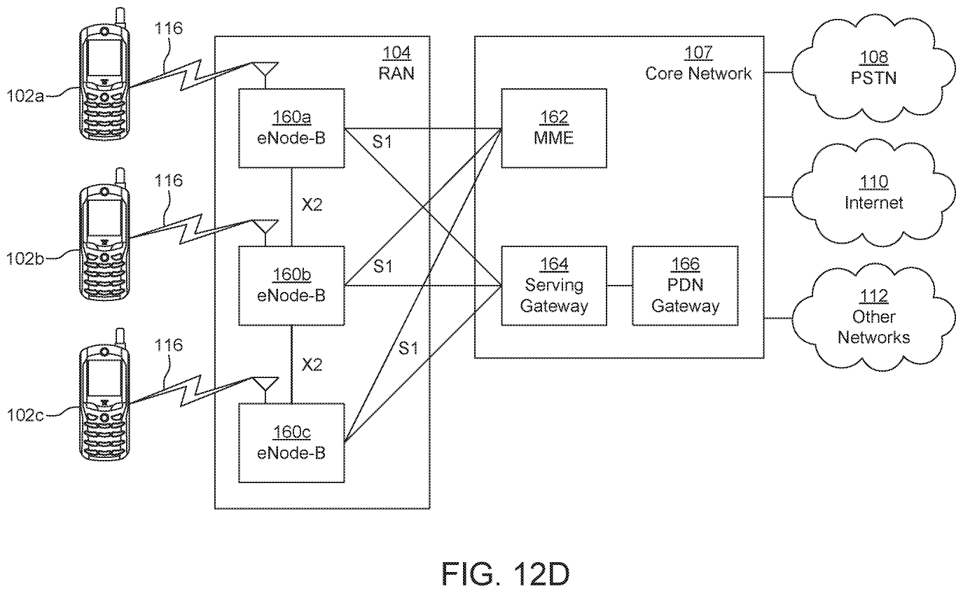

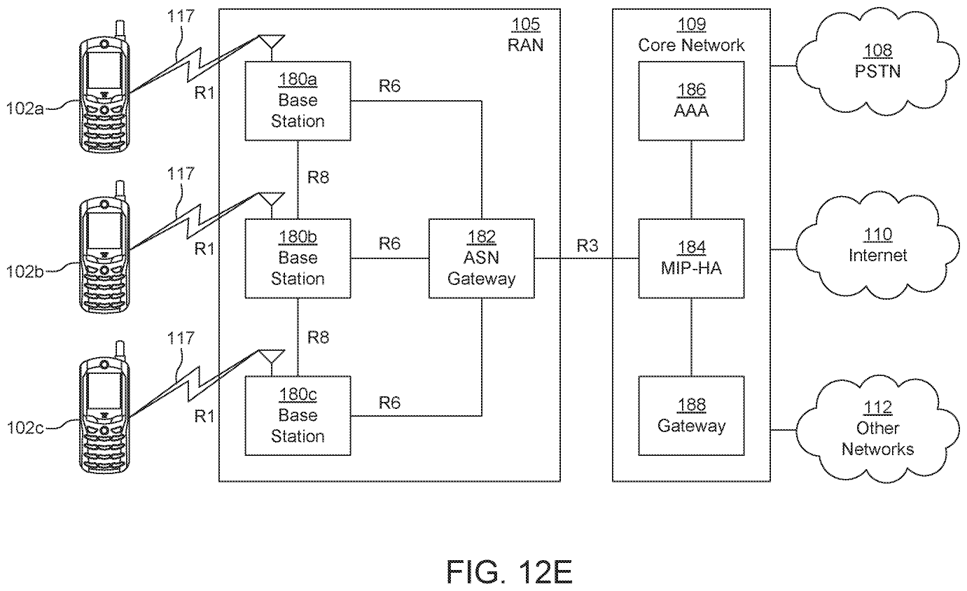

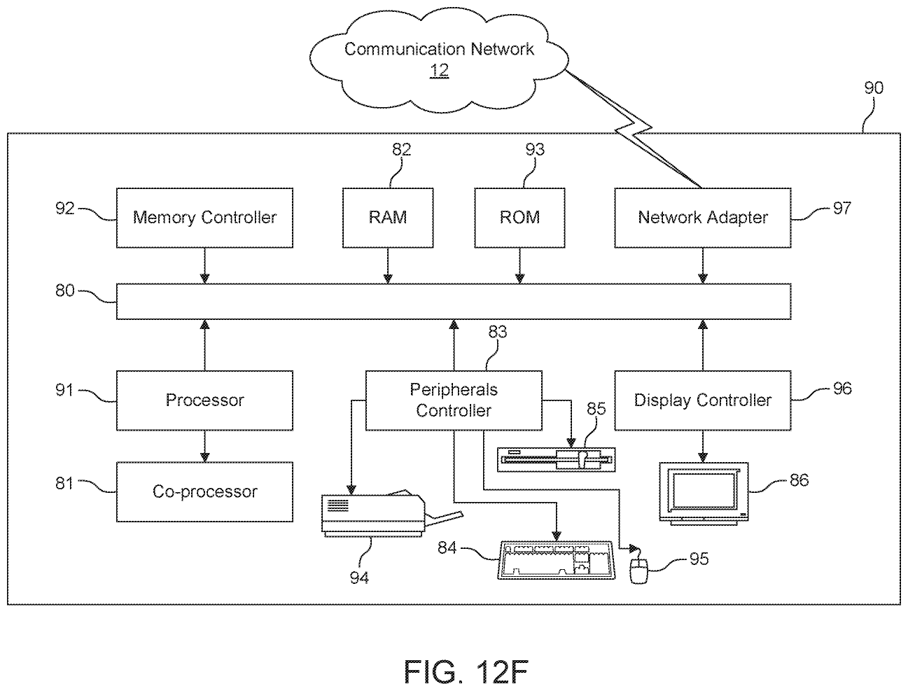

FIG. 12A illustrates one embodiment of an example communications system 100 in which the methods and apparatuses described and claimed herein may be embodied. As shown, the example communications system 100 may include wireless transmit/receive units (WTRUs) 102a, 102b, 102c, and/or 102d (which generally or collectively may be referred to as WTRU 102), a radio access network (RAN) 103/104/105/103b/104b/105b, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d, 102e may be any type of apparatus or device configured to operate and/or communicate in a wireless environment. Although each WTRU 102a, 102b, 102c, 102d, 102e is depicted in FIGS. 12A-12E as a hand-held wireless communications apparatus, it is understood that with the wide variety of use cases contemplated for 5G wireless communications, each WTRU may comprise or be embodied in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, truck, train, or airplane, and the like.

The communications system 100 may also include a base station 114a and a base station 114b. Base stations 114a may be any type of device configured to wirelessly interface with at least one of the WTRUs 102a, 102b, 102c to facilitate access to one or more communication networks, such as the core network 106/107/109, the Internet 110, and/or the other networks 112. Base stations 114b may be any type of device configured to wiredly and/or wirelessly interface with at least one of the RRHs (Remote Radio Heads) 118a, 118b and/or TRPs (Transmission and Reception Points) 119a, 119b to facilitate access to one or more communication networks, such as the core network 106/107/109, the Internet 110, and/or the other networks 112. RRHs 118a, 118b may be any type of device configured to wirelessly interface with at least one of the WTRU 102c, to facilitate access to one or more communication networks, such as the core network 106/107/109, the Internet 110, and/or the other networks 112. TRPs 119a, 119b may be any type of device configured to wirelessly interface with at least one of the WTRU 102d, to facilitate access to one or more communication networks, such as the core network 106/107/109, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114b may be part of the RAN 103b/104b/105b, which may also include other base stations and/or network elements (not shown), such as a base station controller (BSC), a radio network controller (RNC), relay nodes, etc. The base station 114a may be configured to transmit and/or receive wireless signals within a particular geographic region, which may be referred to as a cell (not shown). The base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, in an embodiment, the base station 114a may include three transceivers, e.g., one for each sector of the cell. In an embodiment, the base station 114a may employ multiple-input multiple output (MIMO) technology and, therefore, may utilize multiple transceivers for each sector of the cell.

The base stations 114a may communicate with one or more of the WTRUs 102a, 102b, 102c over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b and/or TRPs 119a, 119b over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b and/or TRPs 119a, 119b may communicate with one or more of the WTRUs 102c, 102d over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b and TRPs 119a, 119b in the RAN 103b/104b/105b and the WTRUs 102c, 102d, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c, or RRHs 118a, 118b and TRPs 119a, 119b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A). In the future, the air interface 115/116/117 may implement 3GPP NR technology.

In an embodiment, the base station 114a in the RAN 103/104/105 and the WTRUs 102a, 102b, 102c, or RRHs 118a, 118b and TRPs 119a, 119b in the RAN 103b/104b/105b and the WTRUs 102c, 102d, may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 12A may be a wireless router, Home Node B, Home eNode B, or access point, for example, and may utilize any suitable RAT for facilitating wireless connectivity in a localized area, such as a place of business, a home, a vehicle, a campus, and the like. In an embodiment, the base station 114c and the WTRUs 102e, may implement a radio technology such as IEEE 802.11 to establish a wireless local area network (WLAN). In an embodiment, the base station 114c and the WTRUs 102d, may implement a radio technology such as IEEE 802.15 to establish a wireless personal area network (WPAN). In yet another embodiment, the base station 114c and the WTRUs 102e, may utilize a cellular-based RAT (e.g., WCDMA, CDMA2000, GSM, LTE, LTE-A, etc.) to establish a picocell or femtocell. As shown in FIG. 12A, the base station 114b may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication.

Although not shown in FIG. 12A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d, 102e to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 and/or RAN 103b/104b/105b or a different RAT.

Some or all of the WTRUs 102a, 102b, 102c, 102d in the communications system 100 may include multi-mode capabilities, e.g., the WTRUs 102a, 102b, 102c, 102d, and 102e may include multiple transceivers for communicating with different wireless networks over different wireless links. For example, the WTRU 102e shown in FIG. 12A may be configured to communicate with the base station 114a, which may employ a cellular-based radio technology, and with the base station 114c, which may employ an IEEE 802 radio technology.

FIG. 12B is a block diagram of an example apparatus or device configured for wireless communications in accordance with the embodiments illustrated herein, such as for example, a WTRU 102. As shown in FIG. 12B, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to, transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 12B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 12B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in an embodiment, the transmit/receive element 122 may be an antenna configured to transmit and/or receive RF signals. Although not shown in FIG. 12A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, e.g., the WTRUs 102a, 102b, 102c, and 102d may include multiple transceivers for communicating with different wireless networks over different wireless links. For example, the WTRU 102c shown in FIG. 12A may be configured to communicate with the base station 114a, which may employ a cellular-based radio technology, and with the base station 114b, which may employ an IEEE 802 radio technology.

FIG. 12B is a block diagram of an example apparatus or device configured for wireless communications in accordance with the embodiments illustrated herein, such as for example, a WTRU 102. As shown in FIG. 12B, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 12B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 12B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 12B as a single element, the WTRU 102 may include any number of transmit/receive elements 122. More specifically, the WTRU 102 may employ MIMO technology. Thus, in an embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit). The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In an embodiment, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The WTRU 102 may connect to other components, modules, or systems of such apparatuses or devices via one or more interconnect interfaces, such as an interconnect interface that may comprise one of the peripherals 138.

FIG. 12C is a system diagram of the RAN 103 and the core network 106 according to an embodiment. As noted above, the RAN 103 may employ a UTRA radio technology to communicate with the WTRUs 102a, 102b, and 102c over the air interface 115. The RAN 103 may also be in communication with the core network 106. As shown in FIG. 12C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 12C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro-diversity, security functions, data encryption, and the like.

The core network 106 shown in FIG. 12C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 12D is a system diagram of the RAN 104 and the core network 107 according to an embodiment. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 12D, the eNode-Bs 160a, 160b, 160c may communicate with one another over an X2 interface.

The core network 107 shown in FIG. 12D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 12E is a system diagram of the RAN 105 and the core network 109 according to an embodiment. The RAN 105 may be an access service network (ASN) that employs IEEE 802.16 radio technology to communicate with the WTRUs 102a, 102b, and 102c over the air interface 117. As will be further discussed below, the communication links between the different functional entities of the WTRUs 102a, 102b, 102c, the RAN 105, and the core network 109 may be defined as reference points.

As shown in FIG. 12E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell in the RAN 105 and may include one or more transceivers for communicating with the WTRUs 102a, 102b, 102c over the air interface 117. In an embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, and 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, and 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 12E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 12E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

The core network entities described herein and illustrated in FIGS. 12A, 12C, 12D, and 12E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 12A, 12B, 12C, 12D, and 12E are provided by way of example only, and it is understood that the subject matter disclosed and claimed herein may be embodied or implemented in any similar communication system, whether presently defined or defined in the future.

FIG. 12F is a block diagram of an exemplary computing system 90 in which one or more apparatuses of the communications networks illustrated in FIGS. 12A, 12C, 12D and 12E may be embodied, such as certain nodes or functional entities in the RAN 103/104/105, Core Network 106/107/109, PSTN 108, Internet 110, or Other Networks 112. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 can be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adapter 97, that may be used to connect computing system 90 to an external communications network, such as the RAN 103/104/105, Core Network 106/107/109, PSTN 108, Internet 110, or Other Networks 112 of FIGS. 12A, 12B, 12C, 12D, and 12E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

Example scenarios and requirements for New Radio Technologies are described in “3GPP TR 38.913 Study on Scenarios and Requirements for Next Generation Access Technologies; (Release 14), V0.2.0.” Some Key Performance Indicators (KPIs) for eMBB, URLLC and mMTC devices are summarized in Table 1.

TABLE 1
KPIs for eMBB, URLLC and mMTC Devices

| Device | KPI | Description | Requirement |
|---|---|---|---|
| eMBB | Peak data | Peak data rate may be the | 20 Gbps for |
| | rate | highest theoretical data | downlink |
| | | rate, which is the received data | and |
| | | bits assuming error- | 10 Gbps |
| | | free conditions assignable to a | for |
| | | single mobile station, | uplink |
| | | when all assignable radio | |
| | | resources for the | |
| | | corresponding link direction | |
| | | are utilized (e.g., | |
| | | excluding radio resources | |
| | | that are used for physical | |
| | | layer synchronization, | |
| | | reference signals or pilots, | |
| | | guard bands and guard times). | |
| | Mobility | Mobility interruption time | 0 ms for |
| | interruption | may mean the shortest | intra- |
| | time | time duration supported by the | system |
| | | system during which | mobility |
| | | a user terminal cannot exchange | |
| | | user plane packets | |
| | | with any base station during | |
| | | transitions. | |
| | Data Plane | For eMBB value, the evaluation | 4 ms for |
| | Latency | may consider all | UL, and |
| | | typical delays associated with | 4 ms for |
| | | the transfer of the data | DL |
| | | packets in an efficient | |
| | | way (e.g. applicable | |
| | | procedural delay when | |
| | | resources are not pre- | |
| | | allocated, averaged HARQ | |
| | | retransmission delay, | |
| | | impacts of network architecture). | |
| URLLC | Control | Control plane latency may | 10 ms |
| | Plane | refer to the time to move | |
| | Latency | from a battery efficient state | |
| | | (e.g., IDLE) to start of | |
| | | continuous data transfer | |
| | | (e.g., ACTIVE). | |
| | Data Plane | For URLLC the target for | 0.5 ms |
| | Latency | user plane latency for UL | |
| | | and DL. Furthermore, if possible, | |
| | | the latency may also | |
| | | be low enough to support | |
| | | the use of the next | |
| | | generation access technologies | |
| | | as a wireless transport | |
| | | technology that can be used | |
| | | within the next generation | |
| | | access architecture. | |
| | Reliability | Reliability can be evaluated | 1-10-5 |
| | | by the success | within |
| | | probability of transmitting X | 1 ms |
| | | bytes (1) within 1 ms, | |
| | | which is the time it takes | |
| | | to deliver a small data | |
| | | packet from the radio protocol | |
| | | layer ⅔ SDU ingress | |
| | | point to the radio protocol | |
| | | layer ⅔ SDU point of the | |
| | | radio interface, at a certain | |
| | | channel quality (e.g., | |
| | | coverage-edge). | |
| | | NOTE1: Specific value for | |
| | | X is FFS. | |
| mMTC | Coverage | “Maximum coupling | 164 dB |
| | | loss” (MCL) in uplink and | |
| | | downlink between device | |
| | | and Base Station site | |
| | | (antenna connector(s)) for | |
| | | a data rate of [X bps], | |
| | | where the data rate is observed | |
| | | at the egress/ingress | |
| | | point of the radio protocol | |
| | | stack in uplink and | |
| | | downlink. | |
| | UE Battery | User Equipment (UE) battery | 15 years |
| | Life | life can be evaluated | |
| | | by the battery life of the UE | |
| | | without recharge. For | |
| | | mMTC, UE battery life in | |
| | | extreme coverage may be | |
| | | based on the activity of | |
| | | mobile originated data | |
| | | transfer consisting of | |
| | | [200 bytes] Uplink (UL) per | |
| | | day followed by [20 bytes] | |
| | | Downlink (DL) from | |
| | | Maximum Coupling Loss | |
| | | (MCL) of [tbd] dB, | |
| | | assuming a stored energy | |
| | | capacity of [5 Wh]. | |
| | Connection | Connection density may refer | 106 |
| | Density | to the total number of | devices/ |
| | | devices fulfilling specific | km2 |
| | | Quality of Service (QoS) | |
| | | per unit area (per km2). QoS | |
| | | definition may take into | |
| | | account the amount of data | |
| | | or access request | |
| | | generated within a time t_gen | |
| | | that can be sent or | |
| | | received within a given time, | |
| | | t_sendrx, with x % | |
| | | probability. | |

In a first aspect, methods and systems for beam specific uplink transmit power control are disclosed. Due to the very dynamic channel characteristics of each beam and significant gain difference among the directional narrow beams, beam specific UL TPC may be essential for a NR system. In addition, managing the UL TP efficiently to ensure performance and reduce interference may be important for NR UL TCP design.

Thus, for more efficient UL TPC, a Beam Pair Link (BPL) (e.g., the radio link formed by a pair of transmitter and receiver beams) gain difference may be adjusted for each BPL. The BPL gain difference may be caused, for example, by one or more of the following:

DL measurements from the different Reference Signals (RSs) with different power settings, different bandwidths or numerologies, different configurations (e.g. cell specific or UE specific), different precodings for transmitter diversity, different DL beams, etc.;

Different directional antenna gains between DL and UL, between beams of DL and/or UL, etc.; and

Different numerologies and service priorities (e.g. latency, reliability, etc.) for power requirements.

In NR, directional antenna gain with narrow beams may contribute to a signal path loss calculation. Currently in LTE, the UL path loss is estimated based on the received reference signal power on the DL as shown in the example below:

$${P}_{PUSCH , c} ( i ) = min \{ \begin{matrix}{P}_{CMAX , c} ( i ) , \\ 10 {log}_{10} ( {M}_{PUSCH , c} ( i ) ) + {P}_{O \_ PUSCH , c} ( j ) + \\ {α}_{c} ( j ) \cdot {PL}_{c} + {Δ}_{TF , c} ( i ) + {f}_{c} ( i )\end{matrix} \} ( dBm ) \qquad ( 1 )$$

where PL_{c} is the DL path loss estimate calculated in the UE for serving cell c in dB and PL_{c}=referenceSignalPower−higher layer filtered Reference Signal Received Power (RSRP).

The DL path loss based UL open loop power estimation may differ significantly due to BPL gain difference caused by, for example, DL measurements from the different RSs, different directional antenna gains, and/or different numerologies and service priorities (e.g., latency, reliability, etc.).

Tracking the different open loop power estimation parameter values based on the above mentioned factors, such as RSs, antenna gain, numerologies, priorities, etc., may cause significant overhead for system signaling. To reduce the amount of parameters, the Beam Pair Link (BPL) gain difference (Δ_{bpl-k}) for BPL-k or BPL-group-k caused by one or more of the above mentioned factors may be used for adjusting the UL power control. For example, the BPL gain difference may be caused by the difference of antenna gains of DL BPL k or BPL group k (e.g., the pair of gNB/TRP's Transmitter (Tx) beam k or beam group k and UE's Receiver (Rx) beam k) or beam group k and UL BPL k or BPL group k (e.g., the pair of UE's Transmitter (Tx) beam k or beam group k and gNB/TRP's Receiver (Rx) beam k or beam group k). In this example, the BPL gain difference for BPL k or BPL group k may be calculated as the follows:

Δ_{bpl-k}=DL beam pair k gain−UL beam pair k gain,

Δ_{bpl-k}=DL beam pair group k gain−UL beam pair group k gain,

where the group may be formed based on services such as priority or scheduling (latency), reliability, etc., and/or beam association (e.g., the UL beam(s) associated with the best detected or selected DL beam(s)), Quasi-Co-location (QCL) properties (e.g., BPL gain or beam spatial relationship), etc.

Therefore, the UL closed-loop transmit power may be adjusted with beam based BPL gain difference Δ_{bpl-k} using equation (1) for BPL-k or BPL-group-k in the example equation (2) below:

$${P}_{PUSCH , c} ( i ) = min \{ \begin{matrix}{P}_{CMAX , c} ( i ) , \\ 10 {log}_{10} ( {M}_{PUSCH , c} ( i ) ) + {P}_{O \_ PUSCH , c} ( j ) + \\ {α}_{c} ( j ) \cdot {PL}_{c} + Δbpl\_k + {Δ}_{TF , c} ( i ) + {f}_{c} ( i )\end{matrix} \} \qquad ( 2 )$$

Additionally or alternatively, open loop TPC parameters (e.g., the UE's targeted power at the receiver) may be statically or semi-statically adjusted with the BPL gain difference for each BPL (e.g., BPL k). The parameters may also be adjusted as BPL group based due to services such as priority or scheduling (e.g., latency), reliability, etc. For example, the beam expected power for BPL group k may be set based on the same service reliability for group k of beams. The parameters may also be adjusted as group based due to the beam association, beam Quasi-Co-location (QCL) properties, etc. For example, the set of parameters may be the same for a group of beams which are quasi-co-locationed with similar channel properties (e.g., same BPL gain difference).

A Beam pair link gain difference Δ_{bpl-k} for the BPL-k or BPL-group-k (caused by the gain difference between DL BPL k or BPL group k and UL BPL k or BPL group k, as an example) may be calculated based on the UE's DL path loss measurement L_{DLpath} and the gNB/TRP's UL path loss measurement L_{ULpath} or the UL power adjustment UL_{adj} calculated by the gNB for BPL-k or BPL-group-k as shown in the following equations:

Δ_{bpl_k}=L_{ULpath_k}−L_{DLpath_k},

Δ_{bpl_k}=UL_{adj_k}.

A Beam pair link gain difference Δ_{bpl_k} (caused by the gain difference between DL BPL k or BPL group k and UL BPL k or BPL group k, as an example) may also be derived from gNB's Transmit Power Control (TPC) bit:

Δ_{bpl_k}=TPC_k×Δ_{adj_k},

where “TPC_k=1” for increasing power, “−1” for decreasing power, “0” for no change, and Δ_{adj_k} is the power adjustment either preconfigured, indicated in System Information (SI), or signaled to UE via Radio Resource Control (RRC), Medium Access Control (MAC) Control Element (CE) or DL Control Information (DCI).

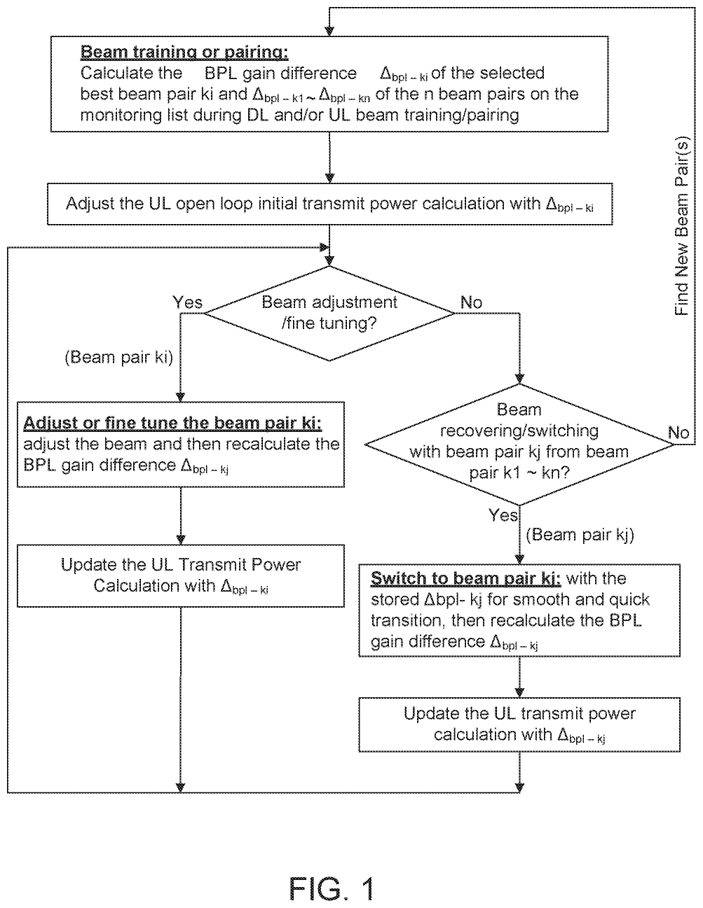

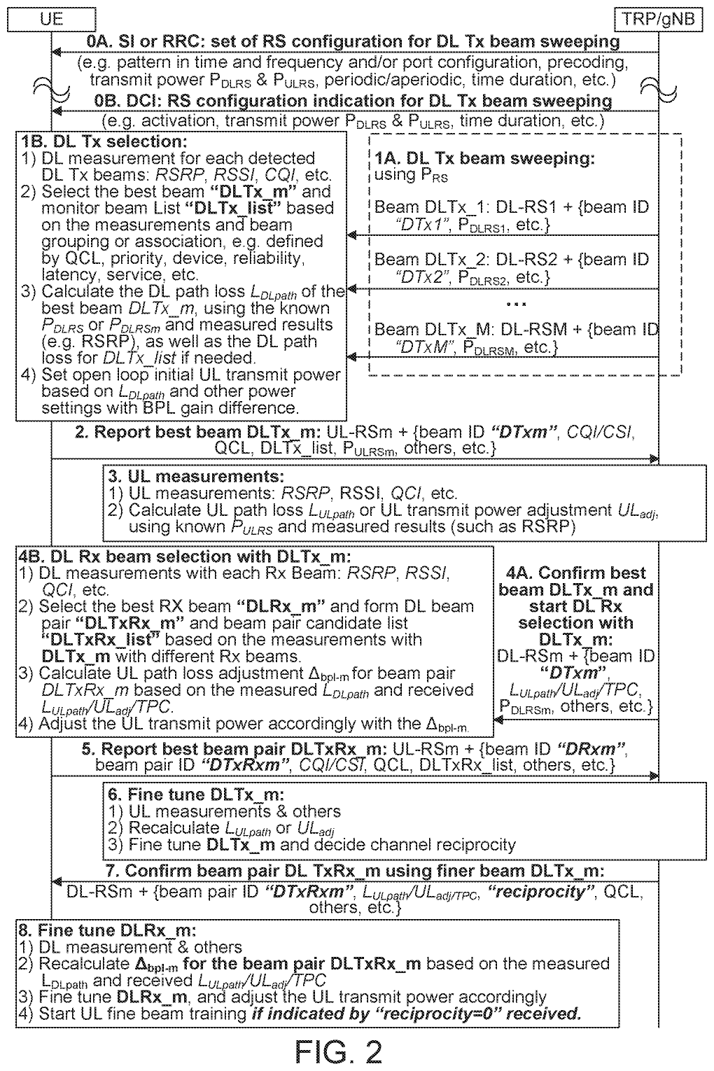

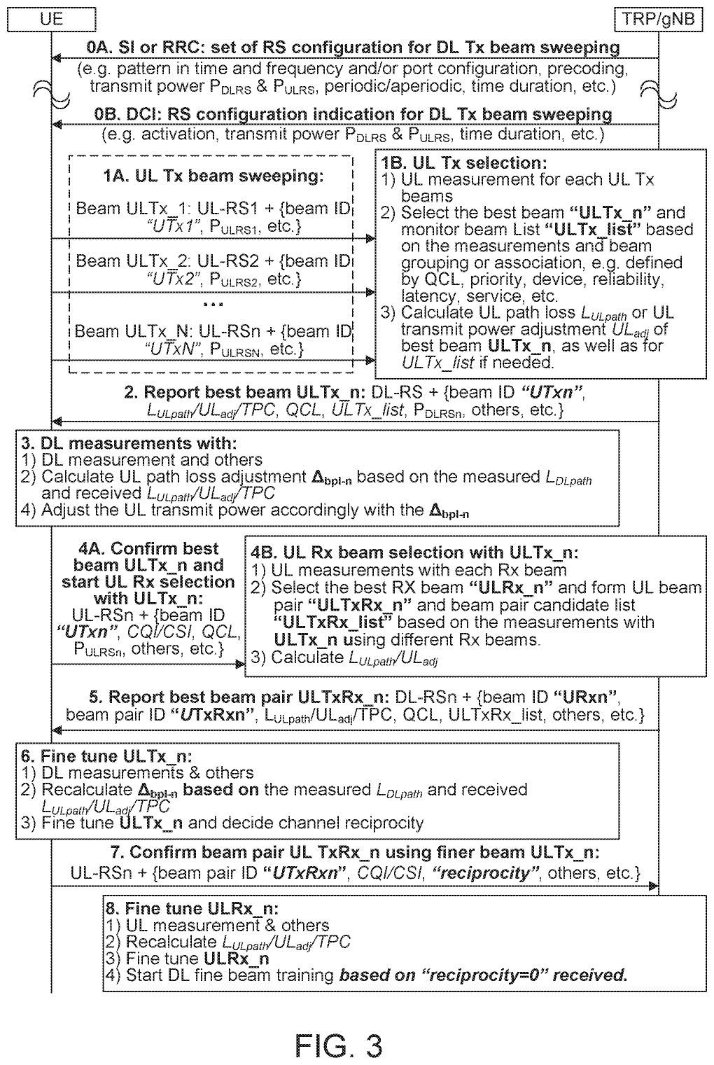

Example methods for adjusting and estimating the beam pair link gain difference is illustrated in FIGS. 1-3. FIG. 1 shows an example general operations with BPL gain difference adjustment. FIG. 2 shows an example of BPL gain difference estimation with DL beam training or pairing. FIG. 3 shows an example of BPL gain difference estimation with UL beam training or pairing. For simplifying the illustration, a BPL (e.g., BPL k) is used as an example, but all the mechanisms are also applicable to BPL group, (e.g., BPL group k).

As shown in FIG. 1, an example method for adjusting the beam pair link gain difference Δbpl_ki and Δbpl_kj is illustrated in a flow chart as the follows.

At step 1, a BPL gain difference (i.e., Δbpl_ki for BPL ki as the selected best beam pair and/or Δbpl_k˜Δbpl_kn as the n beam pairs on the monitoring list) may be calculated during beam training or pairing operations.

At step 2, the UL open loop initial transmit power calculation may be adjusted with the BPL gain difference Δbpl_ki for BPL ki, as an example.

At step 3, it may be determined whether beam adjustment/fine tuning is needed for BPL ki.

If it is determined that beam adjustment/fine tuning is needed for BPL ki:

At step 4, the BPL gain difference Δbpl_ki for BPL ki may be adjusted or fine tuned, and

At step 5, the UL transmit power calculation may be updated with the adjusted BPL gain difference Δbpl_ki.

If it is determined that beam adjustment/fine tuning is not needed at step 3:

At step 6, it may be determined whether beam recovering or beam switching is needed.

If beam recovering or beam switching is not needed at step 6:

At step 7, new beam pairs may be searched for.

If beam recovering or beam switching is needed at step 6:

At step 8, the BPL gain difference may be switched with a stored BPL gain difference accordingly (i.e., Δbpl_kj for switched BPL kj) for a smooth and quick UL power control transition. The BPL gain difference (i.e., Δbpl_kj for switched BPL kj) may also be recalculated or updated after switching, and

At step 9, the UL power calculation may be updated with the BPL gain difference Δbpl_kj for switched BPL kj.

FIG. 2 shows a flow chart of an example method for the estimation of a beam pair link gain difference Δbpl_k for BPL k during DL beam training or pairing.

At step 0A, via SI or RRC, a Reference Signal (RS) configuration for DL Tx beam sweeping may be sent from the TRP/gNB to the UE.

At step 0B, an RS configuration indication for DL Tx beam sweeping may be updated from the TRP/gNB to the UE.

At step 1A, DL Tx beam sweeping may be performed by the TRP/gNB. Each DL beam contain DL RS, e.g. DL-RS1 on beam DLTx_1, beam ID or indication, e.g., “DTx1” for beam DLTx_1, power of the RS, etc.

At step 1B, a DL measurement of each DL beam is conducted (e.g., Reference Signal Received Power (RSRP), Received signal Strength Indication (RSSI), or Channel Quality Indication (CQI) measurement of the DL RS1 on DL beam DLTx_1). DL Tx beam selection may be performed by the UE as well as the candidate beam monitoring list update, based on the DL measurement, beam grouping, beam association, QCL, and others such as service priority, device capability, reliability requirement, latency requirement, service type, etc. Then, the DL path loss may be calculated for the selected beam and/or the candidate beams on the monitoring list. For example, L_{DLpath} is calculated with the RSRP measurement on DL RS-m for the selected beam DLTx_m. The initial open loop transmit power is set according to the measured DL path loss and initial BPL gain difference.

At step 2, the best beam DLTx_m may be reported by the UE to the TRP/gNB with the UL RS (e.g., Demodulation Reference Signal (DMRS) or Sound Reference signal (SRS) on UL for UL-RSm), beam ID (e.g., DTxm with index m), as well as the measure result (e.g., RSRP, CQI, etc.), spatial relationship (e.g., QCL type), and the monitoring candidate beam list, etc.

At step 3, UL measurements may be calculated by the TRP/gNB, e.g., RSRP measured on UL-RSm or RSSI. The UL path loss, UL transmit power adjustment or UL Transmit Power Control may be calculated based on the UL measurement such as RSRP as an example.

At step 4A, the best beam DLTx_m may be confirmed with UL path loss (i.e. L_{ULpath}) or UL transmit power adjustment (i.e. UL_{adj}) or UL Transmit Power Control command (i.e. TPC), and a DL Rx selection with DLTx_m may be started by the TRP/gNB.

At step 4B, DL measurement is conducted with different Rx beams and DL Rx beam selection with DLTx_m may be performed by the UE based on the measurement. BPL gain difference may be calculated based on the DL measurement and UL path loss (e.g., L_{ULpath}), UL transmit power adjustment (e.g., UL_{adj}) or UL Transmit Power Control command (e.g., TPC). The UL transmit power is adjusted based on the updated BPL gain difference (e.g., Δbpl_m for the selected BPL m).

At step 5, the best beam pair DLTxRx_m may be reported by the UE to the TRP/gNB.

At step 6, DLTx_m may be fine tuned by the TRP/gNB.

At step 7, the beam pair DLTxRx_m may be confirmed by the TRP/gNB to the UE using finer beam DLTx_m.

At step 8, DLTx_m may be fine tuned by the UE.

FIG. 3 shows a flow chart of an example method for estimating a beam pair link gain difference Δbpl_k during UL beam training or pairing.

At step 0A, via SI or RRC, an RS configuration for DL Tx beam sweeping may be sent from the TRP/gNB to the UE.

At step 0B, via DCI, an RS configuration indication for DL Tx beam sweeping may be sent from the TRP/gNB to the UE.

At step 1A, UL Tx beam sweeping may be performed by the UE

At step 1B, UL Tx selection may be performed by the TRP/gNB.

At step 2, the best beam ULTx_n may be reported by the TRP/gNB to the UE.

At step 3, DL measurement for each may be calculated by the UE. BPL gain difference may be calculated accordingly, e.g., Δbpl_n for the selected BPL n.

At step 4A, the best beam ULTx_n may be confirmed and a UL Rx selection with ULTx_n may be started by the UE.

At step 4B, UL Rx beam selection with ULTx_n may be performed by the TRP/gNB.

At step 5, the best beam pair ULTxRx_n may be reported by the TRP/gNB to the UE.

At step 6, ULTx_n may be fine tuned by the UE. The BPL gain difference may be updated accordingly (e.g., Δbpl_n for the selected BPL n).

At step 7, the beam pair ULTxRx_m may be confirmed by the UE to the TRP/gNB using finer beam ULTx_n.

At step 8, ULTx_n may be fine tuned by the TRP/gNB.

In a second aspect, methods and systems are disclosed for uplink transmit power control for a user equipment at an idle or an inactive state. An example method may comprise detecting a plurality of beams in a downlink transmission to a user equipment, selecting a given one of the beams based on one or more downlink measurements, calculating a downlink path loss based on the selected beam, estimating an uplink path loss based on the downlink path loss, determining an initial transmit power level for the user equipment based on the estimated uplink path loss, and transmitting at least one UL beam associated with the detected downlink beam in an uplink transmission based on the determined initial power level.

In this aspect, detecting the plurality of beams in the downlink transmission may comprise performing a beam sweeping operation. The device may be at one of an idle state or an inactive state prior to performing the beam sweeping operation. The one or more downlink measurements may comprise a synchronization error measurement, a received signal strength indicator (RSSI) measurement, and a reference signal received power (RSRP) measurement. The downlink path loss of the selected beam may be calculated based at least on a received signal strength or reference signal received power of the selected beam and the associated transmit power. The reference signal transmit power of the selected beam may be determined based on the physical broadcast channel of the selected beam.

In NR, the Channel State Information-Reference Signal (CSI-RS) is not an always-on RS and a UE may not be able to find the CSI-RS at Idle State after power up or wake up from DRX cycle and/or an Inactive State transferred from an Idle or RRC Connect state. Due to significant differences among the directional antenna gain and more dynamic channels caused by blocking, it may be determined how to set the initial UL transmit power properly to reduce the latency of initial access for NR UL TPC design. Thus, methods may be implemented for Synchronization Signal (SS) burst based DL path loss measurement for initial power setting for UL random access transmission at Idle or Inactive State, and for PDCCH-DRMS based DL path loss measurement for initial power setting for UL random access transmission Idle, Inactive State or RRC Connected State. However, the mechanisms are also applicable to CSI-RS DL based path loss measurement for initial power setting for UL random access transmission Idle or Inactive State or RRC Connected State if CSI-RS is available.

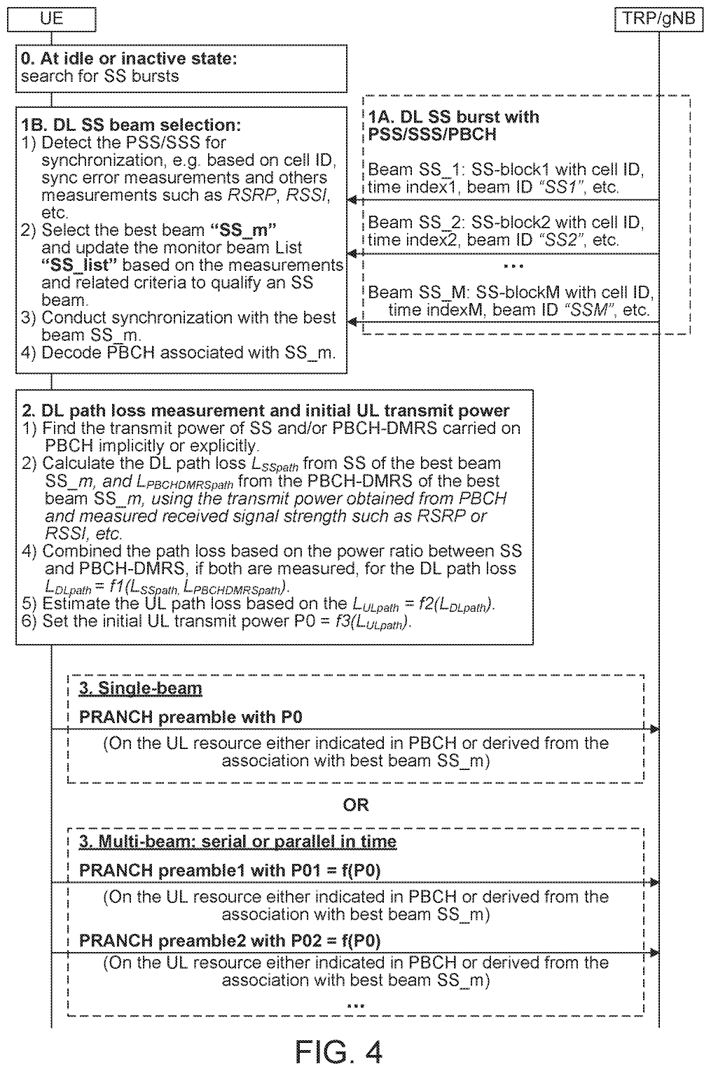

FIG. 4 shows a flow chart of an example method for determining a Synchronization Signal (SS) burst based DL measurements. The method may comprise one or more of the following steps:

At step 0, the UE, at an idle or inactive state, may search for Synchronization Signal (SS) bursts.

At step 1A, the TRP/gNB may be configured to perform a DL SS burst with SS blocks each containing one or more of a Primary Synchronization Signal (PSS), a Secondary Synchronization Signal (SSS) and a Physical Broadcast Channel (PBCH). For example, the beam SS_1 carries SS-block1, which contains PSS, SSS and PBCH, with “cell ID”, SS block's time index “time index 1”, beam indication or ID “SS1”, etc.

At step 1B, the UE may be configured to perform SS beam selection based on the received synchronization signal measurement, such as synchronization error, RSRP, RSSI, etc. measured from Synchronization Signal (SS) or a combination of the measurement with the DMRS of PBCH. The UE selects a best SS beam or SS block, i.e. SS_m, based on the measurement and other criteria (e.g., the Cell ID). The UE may also update the monitoring beam list, i.e. SS_list, based on the measurements of SS beams and reports to higher layer. UE conducts synchronization with the selected SS beam or SS block and decodes the PBCH on the selected SS beam or SS block.

At step 2, the UE may determine a DL path loss measurement and an initial UL transmit power. The Path loss may be based on the measured signal strength such as RSRP or RSSI of the selected SS beam or SS block (e.g., measurement of the SS and/or PBCH-DMRS of the selected SS block) and the transmit power of the measured signal, which may be statically configured in SI (e.g., carried on the PBCH) and/or semi-statically signaled by RRC (e.g., the higher layer). The initial UL transmit power may be estimated with the aforementioned open loop power control parameters and Beam Pair Link (BPL) gain difference if available from the higher layer, i.e. (Δbpl_m) for BPL-m of the selected beam SS_m, for adjusting UE's target power.

At step 3, the first UL transmission from Idle State for RRC Connection Request or from Inactive State for Resume RRC Connection Request via Physical Random Access Channel (PRACH) Preamble, as shown in FIG. 4, may be transmitted from the UE to the TRP/gNB at the transmit power calculated from step 2. The PRACH transmitting occasion(s) (e.g., the beam(s) and UL resource(s)) are associated with the selected SS beam (e.g., either indicated in PBCH of the selected SS beam or derived from the selected beam). For example, the transmitting occasion(s) may be indicated in the PBCH of selected beam SS_m or derived from the selected beam SS_m (e.g., SS beam number m).

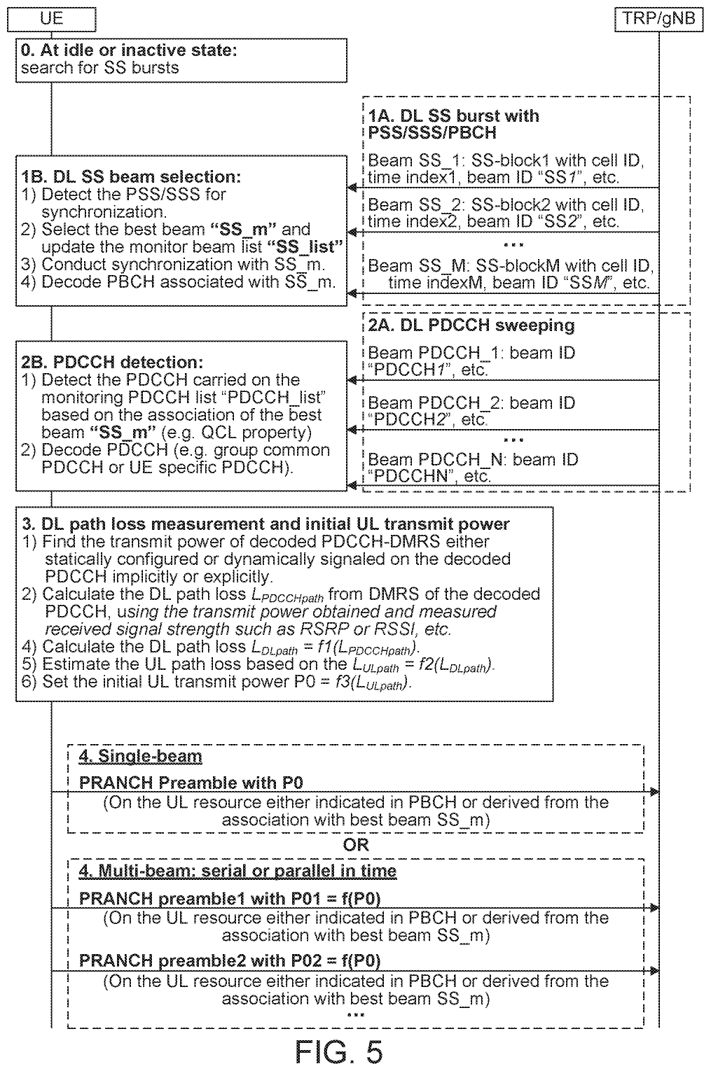

At Idle, Inactive, or RRC Connected State, a UE's PRACH transmission may be triggered by a PDCCH detection. In this case, the Demodulation Reference Signal (DMRS) of the PDCCH may be used as a DL reference signal for DL path loss estimation if CSI-RS is not available as the DL reference signal. FIG. 5 shows a flow chart of an example method for determining a PDCCH-DMRS based path loss measurement. An example method may comprise the following steps:

At step 0, the UE, at an idle or inactive state, may search for SS bursts.

At step 1A, the TRP/gNB may be configured to perform a DL SS burst with SS blocks each containing PSS/SSS/PBCH.

At step 1B, the UE may be configured to perform SS beam selection based on the received synchronization signal measurement such as RSRP, RSSI, etc. measured from the Synchronization Signal (SS), and then decodes the PBCH of the selected SS beam. The UE may also update the monitor beam list based on the measurements on the DL SS beams.

At step 2A, the TRP/gNB may perform DL PDCCH beam sweeping.

At step 2B, the UE may be still at the Idle or Inactive State or the UE may have been switched to RRC Connected State. The UE may detect and decode the PDCCH from the monitoring PDCCH list (e.g., the monitoring occasions for the PDCCH) using the beam associated with the selected beam from step 1B (e.g., the same receiving beam as the beam SS_m as the spatial QCL property).

At step 3, the UE may calculate the DL path loss based on the measurement of the detected PDCCH's DMRS and the initial UL transmit power according to the calculated path loss.

At step 4, the UL transmission from Idle, Inactive, or RRC Connected State, such as the PRACH Preamble as shown, may be made from the UE to the TRP/gNB.

In a third aspect, methods and systems are disclosed for uplink transmit power control for dynamic blocking. In NR, path loss may vary due to blocking for high frequency signals. The conventional LTE-like closed loop power control with accumulated or non-accumulated power adjustment may not be enough to compensate for the sudden path loss. Methods for compensating the path loss caused by dynamic blocking may need to be solved to ensure stable performance in a NR system. Example methods may include dynamic blocking detection based on the measurement of DL RS and dynamically switching between Closed-loop and Open loop UL TCP with the DL path loss caused by dynamic blocking.

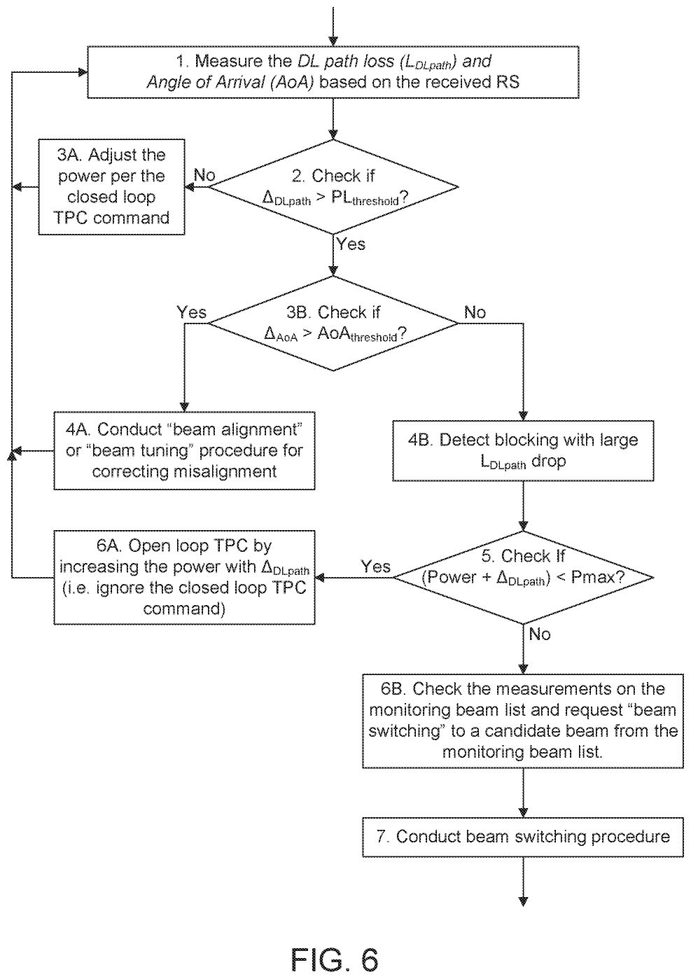

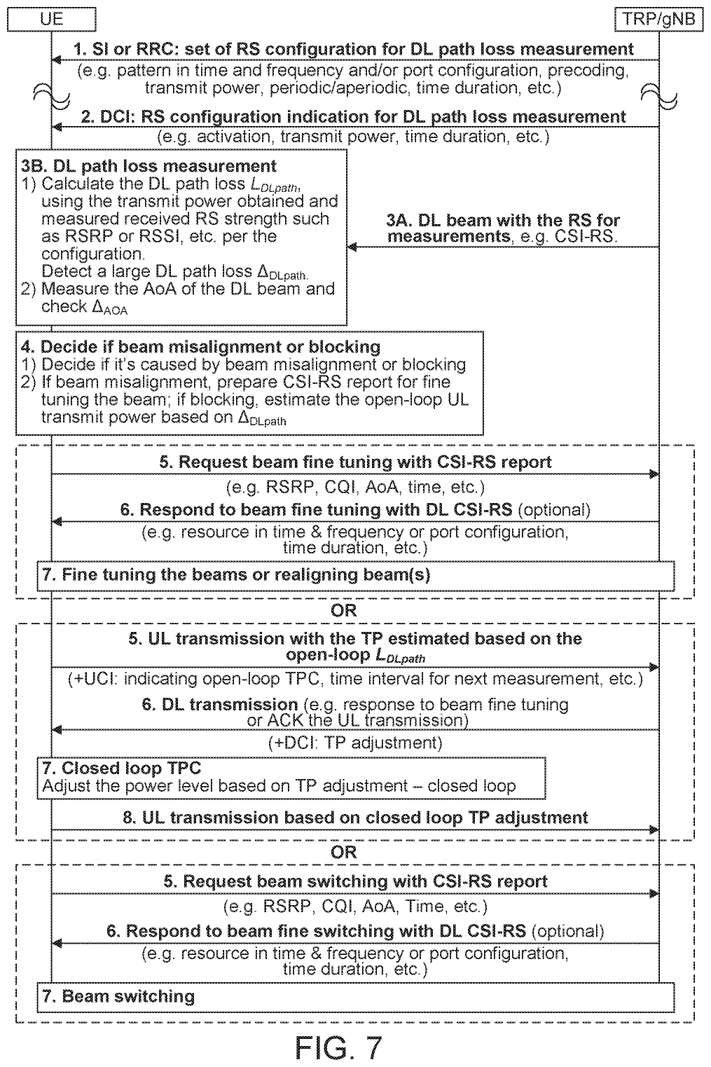

When a large path loss is detected, it may be necessary to identify if it's caused by dynamic blocking or not. If it's caused by beam misalignment, then the beams may be fine tuned for better alignment. Otherwise, it may be caused by dynamic blocking and open loop power control may be adapted to compensate the sharp path loss and ignore the closed loop TPC command. Closed loop TPC may be resumed after receiving a TPC command with the power adjustment. Examples are illustrated in FIG. 6 and FIG. 7, where FIG. 6 shows a UE's operations in a flow chart and FIG. 7 shows the interactions between a UE and TRP/gNB in a call flow.

FIG. 6 shows a flow chart of an example method of TPC for dynamic blocking with TPC switching between closed-loop and open-loop based on detected dynamic blockage, in accordance with the third aspect.

At step 1, the DL path loss (L_{DLpath}) and angle of arrival (AoA) may be measured based on the received reference signal (RS) (e.g., PSS and SSS in an SS block, periodic or aperiodic CSI-RS, DMRS, etc.) using one or multiple receiving beams associated the DL RS.

At step 2, it may be determined if the change in the downlink path loss L_{DLpath} is greater than a threshold from higher layer filter.

If the change in downlink path loss is not greater than the threshold at step 2:

At step 3A, the power may be adjusted per the closed loop TPC command sent from the TRP/gNB.

If the change in downlink path loss is greater than the threshold at step 2:

At step 3B, it may be determined whether the change in the angle of arrival AoA is greater than a threshold.

If the change in the angle of arrival is greater than the threshold at step 3B:

At step 4A, beam alignment or beam tuning may be conducted for correcting misalignment.

If the change in the angle of arrival is not greater than the threshold:

At step 4B, blocking may be detected with a large L_{DLpath} drop and reported to the higher layer, and

At step 5, as indicated by the higher layer with a target power level to bypass the close loop TPC command, it may be determined whether the sum of current transmit power and the change in downlink path loss is less than a maximum power threshold from higher layer.

If the sum of current transmit power and the change in downlink path loss is less than the maximum power threshold at step 5:

At step 6A, open loop TPC may be performed by increasing the power associated with the change in the downlink path loss and the closed-loop power adjustment from TRP/gNB may be ignored by the UE.

If the sum of current transmit power and the change in downlink path loss is not less than the maximum power threshold from high layer at step 5:

At step 6B, measurements on the monitoring beam list may be checked, and beam switching to a candidate beam from the monitoring beam list may be requested and the current beam failure may be reported, and

At step 7, a beam switching procedure may be conducted based on the measurement report.

FIG. 7 shows a call flow of an example method for TPC with dynamic blocking. The method may comprise the following steps:

At step 1, via SI or RRC, a set of RS configurations (e.g., the pattern or resources in time and frequency, the port configuration with QCL types, precoding the transmit diversity, transmit power of RS, periodic or aperiodic and related time duration, etc.) for DL path loss measurements may be sent from a TRP/gNB to a UE.

At step 2, via DCI, an RS configuration indication (e.g. activation for aperiodic, time duration, transmit power, QCL type, etc.) for DL path loss measurement may be send from the TRP/gNB to the UE.

At step 3A, a DL beam with the RS (e.g., CSI-RS) for measurements may be sent from the TRP/gNB to the UE.

At step 3B, DL path loss measurements and angle of arrival measurements may be calculated by the UE with the receiving beam associated with the DL RS.

At step 4, the UE may decide if the path loss change is caused by beam misalignment or by blocking.

If the path loss is caused by misalignment at step 4:

At step 5A, a request for beam fine tuning may be sent from the UE to the TRP/gNB.

At step 6A, the TRP/gNB may optionally respond to the beam fine tuning request with DL RS (e.g. CSI-RS).

At step 7A, the UE and the TRP/gNB may fine tune and/or realign the beams.

If the path loss is caused by blocking at step 4:

At step 5B, the UE may ignore the closed loop TPC command indicated by the higher layer with a target power level, and send a UL transmission to the TRP/gNB with the open loop transmit power (TP) estimated with the measured path loss.

At step 6B, the TRP/gNB may send to the UE a DL transmission response (e.g., acknowledgment (ACK) or retransmission).

At step 7B, the UE may resume closed loop TPC if the path loss is less than the blocking detection threshold.

At step 8, the UE may send to the TRP/gNB the UL transmission based on the closed loop TP adjustment.

If the path loss caused by blocking is more the adjustable maximum power level at step 4:

At step 5C, the UE may send beam switching request to TRP/gNB with measured CSI-RS report.

At step 6C, the TRP/gNB may optionally respond to the UE with the DL CSI-RS for beam selecting.

At step 7C, the UE and the TRP/gNB may perform beam switching based on the CSI-RS measurement at step 6C.

In a fourth aspect, methods and systems are disclosed for uplink transmit power control using mixed numerologies and priorities.

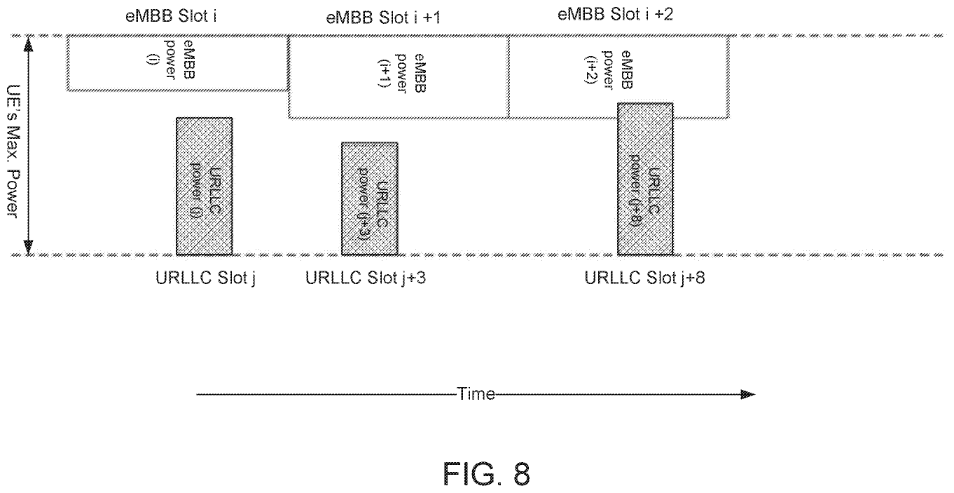

When a UE supports different numerologies (e.g., eMBB and URLLC services as shown in FIG. 8 with different slot duration), it may need to allocate power properly to insure the reliability requirement for one service without degrading the performance for the other service. Methods for managing the power sharing efficiently and the related Power Headroom Report (PHR) may be addressed in NR PHR management. Some example solutions may include hybrid power sharing based on both scheduling and priority, PHR filtering parameters and reporting timer and triggers.

As shown in FIG. 8, a UE's total transmission power is allocated between an eMBB transmission and a URLLC transmission with different numerology (e.g., different time duration as shown). For example, to insure the ultra-reliable performance of the URLLC, the URLLC transmission may take high priority for the UE's UL power allocation and the eMBB may take the secondary for UL power allocation to ensure that the total transmission power from the UE is less than the UE's maximum allowable transmission power range, as illustrated with URLLC power(j) and power(j+3) and eMBB power(i) and power(i+1). But sometimes, the eMBB transmission is scheduled earlier with a certain power level (e.g., eMBB Slot i+2) before a URLLC is scheduled (e.g. URLLC Slot j+8), and power for the later scheduled URLLC may still be allocated per its higher priority for the reliability requirement. Then, the total UL power may exceed the UE's max allowable power, as illustrated with the overlapping between URLLC power(j+8) and eMBB power(i+2). Therefore, proper power sharing scheme may be needed to avoid exceeding the maximum allowable total transmit power from a UE.

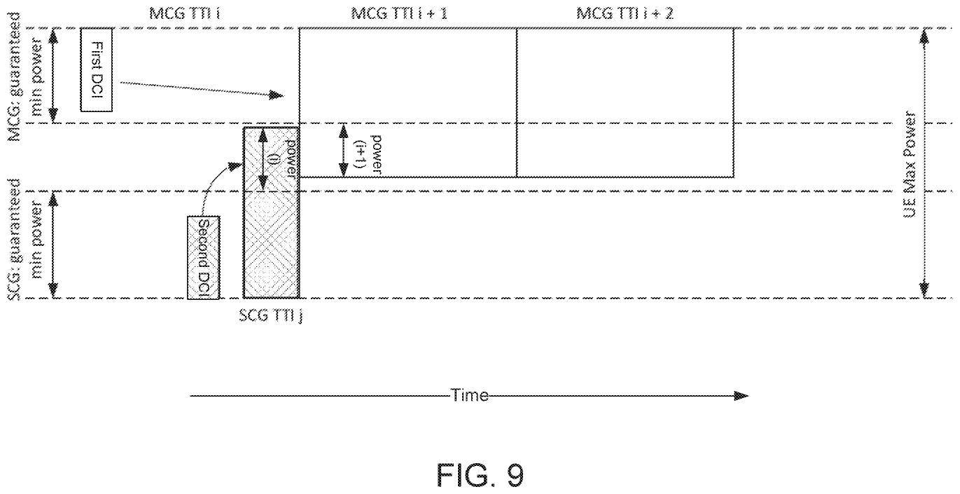

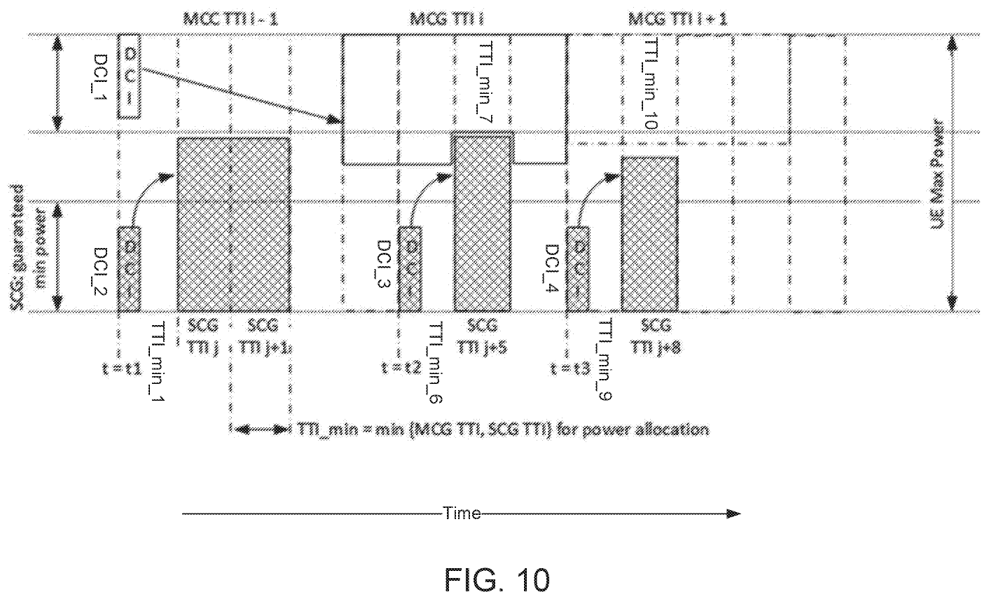

An example of power allocation with different scheduling for dual connections (e.g., one connection to Master Cell Group (MCG) and one connection to Secondary Cell Group (SCG) with different Transmission Time Intervals (TTIs)) is shown in FIG. 9. First, a guaranteed minimum power may be allocated between MCG and SCG, as shown by the dotted lines in FIG. 9. Then, MCG may have a transmission scheduled in MCG TTI i+1 and TTI i+2 with the rest power allocated (e.g., power (i+1)) as indicated by the first DCI before the second DCI scheduling SCG's transmission in SCG TTIj, which may also require the rest power (e.g., power (j)) due to higher priority. Since the later scheduled higher priority transmission with the SCG is completed before the earlier scheduled lower priority transmission with the MCG, the total power from the UE is within the UE's maximum allowable transmit power, no dynamic power adjustment (e.g., power sharing) is needed. However, if the transmission with the SCG overlaps with the transmission with the MCG, then dynamic power adjustment or power sharing may be required to need to total maximum power requirement for the UE, which is shown in the example of FIG. 10.

As illustrated in FIG. 10, due to different numerology, the TTI of MCG is much longer than the TTI of SCG and therefore the DCIs indicating transmissions may not always aligned in time. For example, as shown in FIG. 10, DCI_1 and DCI_2 are detected at the same time but the transmissions scheduled at SCG TTIj and TTIj+1 by DCI_2 are earlier than the transmission at MCG TTIi and TTI i+1 by DCI_1, and DCI_3 detected during the time of the MGC transmission in MGC TTI I indicates another SCG transmission in SCG TTIj+3 overlapping with the MCG transmission in MCG TTI i. In the case of overlapping, dynamic power sharing is required. A hybrid dynamic power sharing (e.g., based on both schedule and priority) example is illustrated herein. A finer time granularity Mini-TTI (e.g., Mini-TTI=min {MCG TTI, SCG TTI}, or the maximum common factor of MCG TTI and SCG TTI if MCG TTI is not an integer number of SCG TTI) may be used for adjusting the power sharing between different numorologies (e.g., TTIs between MCG and SCG) and a hybrid scheme may be used for allocating the power based on both priority and scheduling, as described below:

At time t1 (e.g., the beginning of TTI_min_1), a UE may receive two grants indicated by DCI_1 and DCI_2 respectively for scheduled transmissions, one in MCG TTI i by DCI_1 and the other in SCG TTIj and TTIj+1 by DCI_2. Since the transmissions in SCG TTI j and SCG TTIj+1 are earlier than the transmission in MCG TTI i, then the rest power may be allocated to the SCG transmissions (e.g., the earlier one may be allocated the rest power based on the scheduling. However, the rest power may also be allocated to the transmission to MCG TTI i since the scheduler may not be aware of the transmission scheduled in SCG TTIj and TTIj+1 or the scheduler may be aware that the transmission scheduled in MCG TTI I is later than the ones in SCG.

At time t2 (e.g., the beginning of TTI_min_6), UE may receive another grant for higher priority UL transmission in SCG TTI j+5 indicated by DCI_3, which may be overlapped with the transmission in MCG TTI i. In this case, the UE may allocate the rest power to the transmission in SCGj+5 and reduce the power level for the ongoing MCG transmission in the same time interval, i.e. the dynamic power sharing is adjusted for TTI_min_7 based on the priority.

At time t3 (e.g., the beginning of TTI_min_9), the transmission in SCGj+8 may be allocated with the rest power since it has higher priority.

As shown in FIG. 10, a hybrid dynamic power sharing may be conducted with a finer time granularity (e.g., Mini-TTI) as such: if there is no overlapping in time, allocate the power to the earlier transmission no matter of the priority; if there is an overlapping in time and the total power exceeds the UE's max allowable transmit power, allocate the rest power to the higher priority transmission and scaled down the power of the lower priority transmission in the overlapping time interval in one or multiple Mini-TTIs; if there is an overlapping in time and UE's maximum transmit power is not exceeded, allocate the power to the higher priority transmission first.

The following mechanisms for Power Headroom Report (PHR) may be used with the hybrid power sharing scheme described, for example, in FIG. 10. The values of the parameters may be signaled via RRC, MAC CE, and/or DCI:

The higher layer parameters used in the hybrid dynamic power sharing example shown in FIG. 10 may have one or more of the following characteristics:

Mini-TTI: as illustrated in FIG. 10, a “mini-TTI” may be used to manage mixed numerology transmissions for dynamic power sharing, which may vary periodically with time interval T_{miniTTI} or activated and deactivated by an event trigger, such as transmission overlapping with pre-emption, higher priority traffic, blocking or beam failure, etc.;

Period/Time Duration (T_{miniTTI}): as described previously. The Power Headroom (PH) reporting timer may be set according to this parameter; and

Periodic Flag: set to “1” if periodic, otherwise “0”.

Triggering mechanisms for reporting PH for the following scenarios may comprise one or more of the following:

Blocking, Beam Failure, etc.;

Pre-emption caused by higher priority services such as URLLC; and

Overlapping due to different numerology scheduler at different TRPs/Cells.

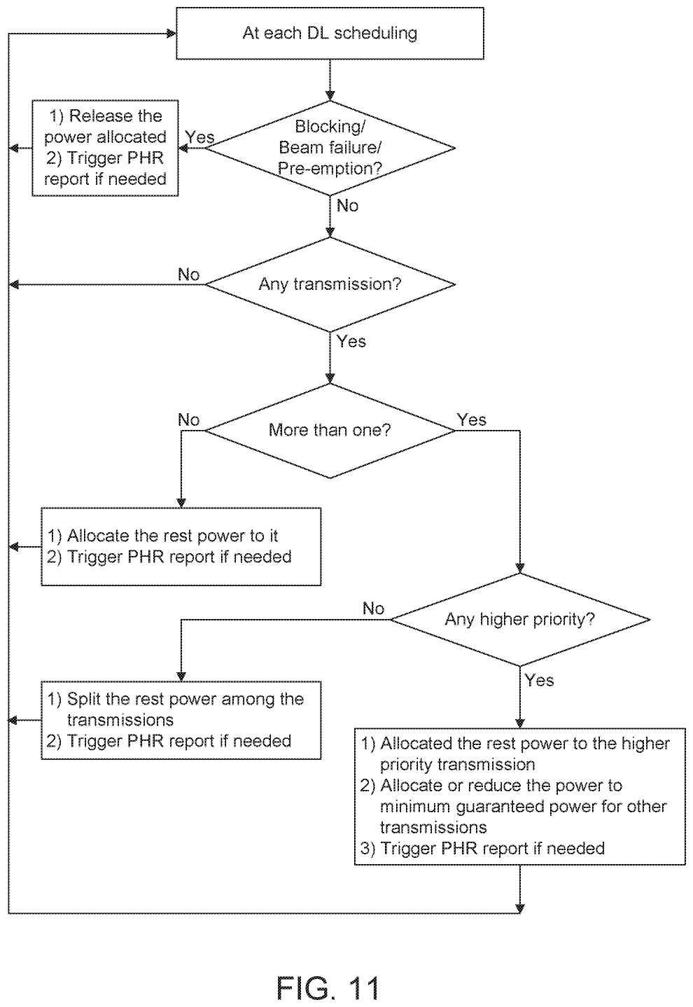

Another example of hybrid dynamic power sharing with PH reporting is illustrated in FIG. 11. The steps of FIG. 11 may be described as follows:

At step 1, at each Mini-TTI, check the DL scheduling with the current power allocation.

At step 2, determine whether there has been a blocking, beam-failure, or a pre-emption.

If there has been a blocking, beam-failure, or a pre-emption at step 2:

At step 3A, release or scale down the current power allocated if the total power exceeds the maximum allowable power, and

At step 3B, trigger PHR report (if needed).

If there has not been a blocking, beam-failure, or a pre-emption at step 2:

At step 4, determine if there has been a new transmission.

If there has been a new transmission at step 4:

At step 5, determine if there has been more than one transmission overlapping in time.

If there has not been more than one transmission overlapping in time at step 5:

At step 6A, allocate the rest power to the transmission, and

At step 6B, trigger a PHR report (if needed).

If there has been more than one transmission overlapping in time at step 5:

At step 7, determine if there is a transition with a higher priority.

If there is not a transmission with a higher priority at step 7:

At step 8A, split the rest power among the transmissions, and

At step 8B, trigger the PHR report (if needed).

If there is a transmission with a higher priority at step 7:

At step 9A, allocate the rest power to the higher priority transmission,

At step 9B, allocate or reduce the power to the minimum guaranteed power for the other transmissions, and

At step 9C, trigger a PHR report (if needed).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

The following is a list of acronyms relating to service level technologies that may appear in the description above. Unless otherwise specified, the acronyms used herein refer to the corresponding term listed below:

| | |
|---|---|
| AoA | Angle of Arrival |
| ACK | Acknowledge |
| CE | Control Element |
| CSI-RS | Channel State Information-Reference Signal |
| CRS | Cell Reference Signal |
| DL | Downlink |
| DMRS | DeModulation Reference Signal |
| DRX | Discontinuous Reception |
| eMBB | enhanced Mobile Broadband |
| KPI | Key Performance Indicators |
| LTE | Long Term Evolution |
| MAC | Medium Access Control |
| MCG | Master Cell Group |
| mMTC | massive Machine Type Communication |
| NACK | Non-ACKnowledgement |
| NR | New Radio |
| PBCH | Physical Broadcast Channel |
| PDCCH | Physical Downlink Control Channel |
| PHR | Power Headroom Report |
| PRACH | Physical Random Access Channel |
| PUSCH | Physical Uplink Shared Data Channel |
| RAN | Radio Access Network |
| RRC | Radio Resource Control |
| SCG | Secondary Cell Group |
| SI | System Information |
| SRS | Sounding Reference Signal |
| SS | Synchronization Signal |
| TTI | Transmit Time Interval |
| UE | User Equipment |
| UL | Uplink |
| URLLC | Ultra-Reliable and Low Latency Communications |

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations or functions described herein may be implemented in the form of such computer executable instructions, executing on the processor of an apparatus or computing system configured for wireless and/or wired network communications. Computer readable storage media include volatile and nonvolatile, removable and non-removable media implemented in any non-transitory (e.g., tangible or physical) method or technology for storage of information, but such computer readable storage media do not includes signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which can be used to store the desired information and which can be accessed by a computing system.

What is claimed:

1. A method comprising:
detecting a plurality of beams in a downlink transmission to a user equipment;
selecting a given one of the beams based on one or more downlink measurements;
calculating a downlink path loss based on the selected beam;
estimating an uplink path loss based on the downlink path loss; and
determining an initial transmit power for the user equipment initial uplink transmission using a physical random access channel based on the estimated uplink path loss.

2. The method of claim 1, wherein detecting the plurality of beams in the downlink transmission comprises performing a beam sweeping operation.

3. The method of claim 2, wherein the user equipment is at one of an idle state or an inactive state prior to performing the beam sweeping operation.

4. The method of claim 1, wherein the one or more downlink measurements comprise a synchronization error measurement, a received signal strength indicator (RSSI) measurement, and a reference signal received power (RSRP) measurement.

5. The method of claim 1, wherein the downlink path loss of the selected beam is calculated based at least on a reference signal received power of the selected beam and a transmit power of the reference signal.

6. The method of claim 5, wherein the transmit power of the reference signal is determined based on system information carried on a physical broadcast channel.

7. The method of claim 5, wherein the transmit power of the reference signal is determined based on a configuration or a signal from a higher layer.

8. The method of claim 1, further comprising transmitting at least one beam in an uplink transmission based on the determined initial transmit power.

9. A user equipment comprising a processor and a memory, the memory storing computer-executable instructions which, when executed by the processor, cause the user equipment to perform operations comprising:
detecting a plurality of beams in a downlink transmission to the user equipment;
selecting a given one of the beams based on one or more downlink measurements;
calculating a downlink path loss based on the selected beam;
estimating an uplink path loss based on the downlink path loss; and
determining an initial transmit power for the user equipment initial uplink transmission using a physical random access channel based on the estimated uplink path loss.

10. The user equipment of claim 9, wherein detecting the plurality of beams in the downlink transmission comprises performing a beam sweeping operation.

11. The user equipment of claim 10, wherein the user equipment is at one of an idle state or an inactive state prior to performing the beam sweeping operation.

12. The user equipment of claim 9, wherein the one or more downlink measurements comprise a synchronization error measurement, a received signal strength indicator (RSSI) measurement, and a reference signal received power (RSRP) measurement.

13. The user equipment of claim 9, wherein the downlink path loss of the selected beam is calculated based at least on a reference signal received power of the selected beam and a transmit power of the reference signal.

14. The user equipment of claim 13, wherein the transmit power of the selected beam is determined based on system information carried on a physical broadcast channel.

15. The user equipment of claim 13, wherein the transmit power of the reference signal is determined based on a configuration or a signal from a higher layer.

16. The user equipment of claim 9, wherein the instructions, when executed, further cause the user equipment to perform operations comprising transmitting at least one beam in an uplink transmission based on the determined initial transmit power.

17. A computer-readable storage medium comprising computer-executable instructions which, when executed by a processor, cause the processor to perform operations comprising:
detecting a plurality of beams in a downlink transmission to a user equipment;
selecting a given one of the beams based on one or more downlink measurements;
calculating a downlink path loss based on the selected beam;
estimating an uplink path loss based on the downlink path loss; and
determining an initial transmit power for the user equipment initial uplink transmission using a physical random access channel based on the estimated uplink path loss.

18. The computer-readable storage medium of claim 17, wherein detecting the plurality of beams in the downlink transmission comprises performing a beam sweeping operation.

19. The computer-readable storage medium of claim 18, wherein the user equipment is at one of an idle state or an inactive state prior to performing the beam sweeping operation.

20. The computer-readable storage medium of claim 17, wherein the downlink path loss of the selected beam is calculated based at least on a reference signal received power of the selected beam and a transmit power of the reference signal.
